(19) United States
(12) Patent Application Publication
(10) Pub. No.: US 2020/0264703 A1
(43) Pub. Date: Aug. 20, 2020

(54) VIRTUAL REALITY SYSTEMS WITH SYNCHRONOUS HAPTIC USER FEEDBACK

(71) Applicant: Walmart Apollo, LLC, Bentonville, AR (US)

(72) Inventors: Brian Leake, Los Angeles, CA (US); Wyatt M. Thornbury, Marina Del Rey, CA (US); Brian C. Holmes, Los Angeles, CA (US)

(21) Appl. No.: 16/789,058

(22) Filed: Feb. 12, 2020

Related U.S. Application Data
(60) Provisional application No. 62/805,881, filed on Feb. 14, 2019.

(51) Int. Cl. G06F 3/01; G06T 19/00; G02B 27/01

(52) U.S. Cl. CPC G06F 3/016; G02B 27/0176; G06T 19/006; G06F 3/011

(57) ABSTRACT

Methods and systems for providing synchronous haptic feedback to one or more users during a virtual reality experience include a virtual reality device, a gaming computer that generates the virtual reality gameplay to be displayed to a user via the virtual reality device, and a haptic computing device that receives, from the gaming computing device, virtual reality application data indicative of the virtual reality gameplay displayed to the user. The haptic computing device converts the virtual reality application data received from the gaming computing device into haptic output data and sends a control signal including the haptic output data to a controller that in turn transmit an activation signal to one or more haptic devices positioned proximate to user. In response to receipt of the activation signal from the controller, one or more haptic device generates a haptic effect palpable by the user and synchronized with the virtual reality gameplay.

### RELATED APPLICATIONS

This application claims the benefit of U.S. Provisional Application No. 62/805,881, filed Feb. 14, 2019, which is incorporated herein by reference in its entirety.

### TECHNICAL FIELD

This disclosure relates generally to virtual reality (“VR”) systems and, in particular, to VR systems configured to provide synchronous haptic feedback to one or more users.

### BACKGROUND

VR experiences allow users to view and interact with a virtual world as if it were the real world. VR experiences can be used in a variety of applications including, but not limited to, gaming, simulations, presentations, and movies. Conventionally, a user immersed in the VR experience in the visual sense, visually observing a VR gameplay via a virtual reality device (“VRD”), which is typically placed on the head and over the eyes of the user and is coupled to a VR gaming computer.

Virtual characters/avatars controllers by the users within the VR gameplay undergo a variety of actions (e.g., walking (e.g., through a cold or hot environment), running, falling, driving, flying, swimming, etc.)) that translate into in-game haptic sensations attributable to the user-controlled virtual character/avatar. In order to make the VR experience more immersive for the user and as realistic as possible, it is desirable to reproduce, synchronously, and in a proportion complementary to the VR gameplay, one or more of such haptic effects for the user engaged in the VR gameplay via the virtual reality device without significantly increasing the computing power required for the VR gaming computer to render such haptic effects.

### BRIEF DESCRIPTION OF THE DRAWINGS

Disclosed herein are embodiments of systems, apparatuses and methods pertaining to providing synchronous haptic feedback to one or more users during a VR experience. This description includes drawings, wherein:

FIG. 1 shows a system for providing, via two haptic devices, synchronous haptic feedback to a user immersed in a VR experience in accordance with some embodiments;

FIG. 2 is a diagram of a system for providing, via four haptic devices, synchronous haptic feedback to a user immersed in a VR experience in accordance with some embodiments;

FIG. 3 shows a system for providing, via two haptic devices per user, synchronous haptic feedback to two users immersed in a VR experience in accordance with some embodiments;

FIG. 4 is a functional diagram of a haptic computing device in accordance with several embodiments; and

FIG. 5 is a flow diagram of a process of providing, via one or more haptic devices, synchronous haptic feedback to one or more users immersed in a VR experience in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of exemplary embodiments. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Generally speaking, this application describes systems and methods for providing, via one or more haptic devices, synchronous haptic feedback to one or more users immersed in a virtual reality experience, thereby providing the one or more users with a more realistic VR experience. It should be noted that the term realistic does not necessarily imply that the virtual world must look like the “real world” (i.e., the world as it currently exists). Rather, the term realistic is used to describe the degree to which the virtual world appears to be real, as opposed to virtual, to the user engaged in the VR gameplay. For example, a clearly fictional environment (e.g., an environment including humans hunting dinosaurs with guns) may not be realistic in the sense that it is not conceivable in the real world. Rather, the fictional environment would be considered realistic by a user in that it visually appears to the user to be real, as opposed to virtual, especially if the user were to noticeably feel, in the real world, palpable haptic effects (e.g., wind, heat, cold, vibration, etc.) corresponding to the VR action the user is immersed in by controlling a virtual character/avatar within the VR gameplay.

Typically, virtual worlds are rendered in real time (i.e., real, or substantially real, time as a user experiences the virtual world). The virtual worlds are rendered in real time because the world must be rendered based on the user's interaction with the virtual world. For example, if the user looks to his or her left, the objects of the virtual world that are positioned to his or her left must be rendered. As another example, if the user is interacting with an object or is engaged in a physical action in the virtual world, the virtual world must be rendered based on this interaction or action. Real time rendering of VR gameplay, even without the additional processing that would be required to analyze VR gameplay and generate suitable haptic effects in the real world, requires very quick rendering and thus significant computing power.

In some embodiments, a system for providing synchronous haptic feedback to at least one user during a VR experience includes: at least one VR device configured to be mounted to a head of the at least one user and to display VR gameplay to the at least one user; at least one gaming computing device operatively coupled to the at least one VRD and configured to generate the VR gameplay to be displayed to the at least one user via the at least one VRD; a haptic computing device including a programmable processor and being in communication with the at least one gaming computing device and configured to receive, from the at least one gaming computing device, VR application data indicative of the VR gameplay displayed to the at least one user. The processor of the haptic computing device is programmed to convert the VR application data received from the at least one gaming computing device into haptic output data. The system further includes at least one controller configured to receive, from the haptic computing device, a control signal including the haptic output data; and at least one haptic device positioned proximate to the at least one user and being operatively coupled to the at least one controller. In response to receipt by the at least one controller of the control signal including the haptic output data from the haptic computing device, the at least one controller is configured to transmit an activation signal to the at least one haptic device. In response to receipt by the at least one haptic device of the activation signal from the at least one controller, the at least one haptic device is configured to generate a haptic effect palpable by the at least one user and synchronized with the VR gameplay.

In other embodiments, a method for providing synchronous haptic feedback to at least one user during a VR experience includes: providing at least one VRD configured to be mounted to a head of the at least one user and to display VR gameplay to the at least one user; providing at least one gaming computing device operatively coupled to the at least one VRD and configured to generate the VR gameplay to be displayed to the at least one user via the at least one VRD; providing a haptic computing device including a programmable processor and being in communication with the at least one gaming computing device and configured to receive, from the at least one gaming computing device, VR application data indicative of the VR gameplay displayed to the at least one user; converting, via the processor of the haptic computing device the VR application data received from the at least one gaming computing device into haptic output data; providing at least one controller configured to receive, from the haptic computing device, a control signal including the haptic output data; providing at least one haptic device positioned proximate to the at least one user and being operatively coupled to the at least one controller; in response to receipt by the at least one controller of the control signal including the haptic output data from the haptic computing device, transmitting, via the at least one controller, an activation signal to the at least one haptic device; and in response to receipt by the at least one haptic device of the activation signal from the at least one controller, generating, via the at least one haptic device, a haptic effect palpable by the at least one user and synchronized with the VR gameplay.

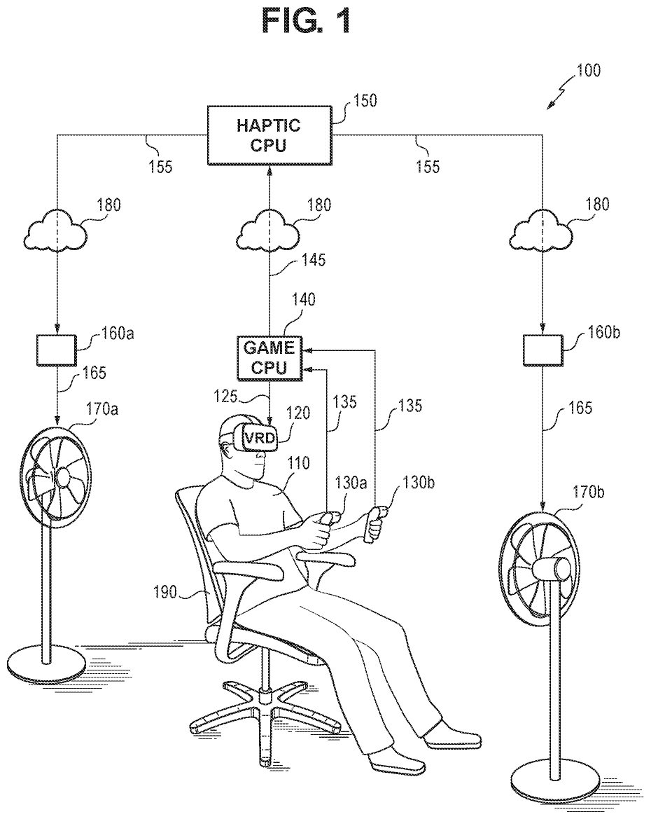

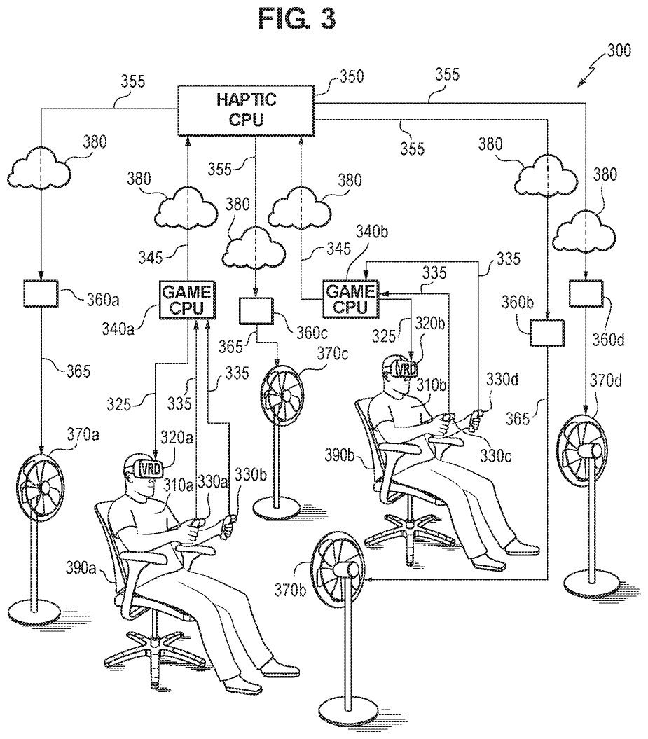

FIG. 1 shows one exemplary embodiment of a system 100 for providing synchronous haptic feedback to a user 110 by way of two haptic devices 120a, 120b during a VR experience. While FIG. 1 shows only one user 110 immersed in the VR experience, it will be appreciated that the system 100 may be configured for multiple (e.g., 2, 3, 4, 5, 10, or more) users. For example, an exemplary system 300 shown in FIG. 3 is configured for two users 210a, 210b immersed in the VR experience. In the exemplary embodiment illustrated in FIG. 1, the user 110 is shown sitting in a chair 190, which could be a conventional office-type chair, or a more specialized gaming chair that may be configured to be controlled by the Haptic CPU 150 (described in more detail below) to tilt (e.g., forward, backward, and side-to-side) synchronously to the movement being experienced within the VR gameplay environment by the user-controlled virtual character/avatar.

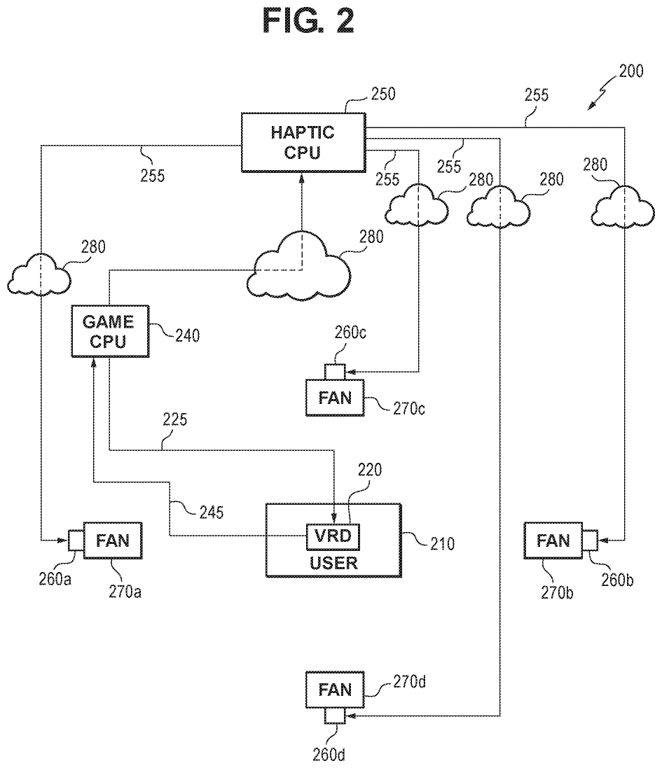

While the exemplary chairs and haptic devices shown in FIGS. 1 and 3 as separate devices that are spaced from one another, it will be appreciated that, in some embodiments, any of the chairs 190, 390a, 390b may be gaming chairs that are physically coupled to and/or physically incorporate one or more of the haptic devices referred to herein. For example, in some aspects, a gaming chair usable with any of systems 100, 200, 300 may be configured to physically incorporate a fan/air blower, a heater, a cooler, a rumbling/shaking device, or the like to provide multiple different haptic effects to the user 110 during VR gameplay. It will also be appreciated that the VR systems described herein may be experienced by the user 110 without using the chair 190 and while standing upright. Similarly, while the exemplary haptic controllers 160a, 160b, 360a-d and haptic devices 170a, 170b, 370a-d are shown in FIGS. 1 and 3 as separate devices that are spaced from one another, it will be appreciated that, in some embodiments, the haptic controllers 160a, 160b, 360a-d may be physically incorporated and/or directly physically coupled to their respective haptic devices 170a, 170b, 370a-d, as shown, by way of example, in FIG. 2.

In the embodiment shown in FIG. 1, the system 100 includes a VRD 120, which is, in effect, the user interface that visually displays the VR gameplay to the user 110. The exemplary VRD 120 may include a display (e.g. LCD, LED, or the like) for visually displaying the VR gameplay to the user 110 when the VRD 120 is worn on the head of the user 110 and over the eyes of the user 110. In addition, in the embodiment illustrated in FIG. 1, the VRD 120 is operatively coupled (e.g., via communication channel 135, which may be wired or wireless) to a pair of VR gaming controllers 130a, 130b, which, when moved and/or otherwise interacted with by the user 110, control the movement of a virtual character or avatar controlled by the user 110 within the VR gameplay. It will be appreciated that the systems 100 and 300 are illustrated with hand-held VR gaming controllers 130a, 130b, 330a, 330b, 330c, 330d by way of example only, and that the systems 100 and 300 may be implemented such that the users 110, 310a, 310b experience the same VR gameplay without the use of hand-held VR gaming controllers 130a, 130b. In other words, the VR gaming controllers 130a, 130b, 330a, 330b, 330c, 330d are optional in some implementations of the systems and methods described herein.

In some embodiments, the VR gaming controllers 130a, 130b include includes one or more sensors capable of detecting movement of the VR gaming controllers 130a, 130b. For example, the sensors included in the VR gaming controllers 130a, 130b may include, but are not limited to, a gyroscope to detect an orientation of each of the VR gaming controllers 130a, 130b, light sensors to detect movement of the VR gaming controllers 130a, 130b relative to external marking lights, position sensors to detect the relative position and/or distance of the VR gaming controllers 130a, 130b, velocity sensors to detect the speed of movement of the VR gaming controllers 130a, 130b by the user 110, or the like. In some embodiments, the VR gaming controllers 130a, 130b are configured (e.g., by including buttons, switches, pads, etc.) to permit the user 110 to provide input affecting action of the virtual character/avatar within the VR gameplay being displayed to the user 110 via the VRD 120 without physically moving the VR gaming controllers 130a, 130b relative to each other.

In the embodiment illustrated in FIG. 1, the system 100 includes a gaming computing device (“Game CPU”) 140 operatively coupled to the VRD 120. While the term “Game CPU” is used, it will be appreciated that the Game CPU may be used to generated VR game play including, but not limited to games, real life activity simulations, various presentations, movies, or the like. Generally, the Game CPU 140 performs the computing operations necessary to generate the VR gameplay to be displayed to the user 110 via the VRD 120. In some aspects, the movement and/or orientation and/or position and/or velocity data collected by the sensor(s) of the VR gaming controllers 130a, 130b is transmitted from the VR gaming controllers 130a, 130b (e.g., via a communication channel 145, which may be wired or wireless) to the Game CPU 140. The Game CPU 140 then updates the VR gameplay and renders the objects and/or scenes updated within the VR gameplay based on the movement of the hands of the user 110 and the associated movement of the VR gaming controllers 130a, 130b. The updated VR gameplay data is then transmitted from the Game CPU 140 (e.g., via a communication channel 125, which may be wired or wireless) to the VRD 120 to be observed and interacted with by the user 110.

In some embodiments, the Game CPU 140 renders the VR gameplay on the display of the VRD 120 by rendering, in real time, or near real time, the graphical objects representing the virtual character/avatar and the background (e.g., landscape, buildings, roads, ground/aerial/sea vehicles, weapons, other virtual characters/avatars, etc.) that the virtual character/avatar controlled by the user 110 interacts with as part of the VR gameplay. In one aspect, during the VR experience, the Game CPU 140 renders the VR gameplay and receives data representative of movement and/or relative position/orientation of the VR gaming controllers 130a, 130b physically manipulated by the user 110, and generates VR gameplay that is synchronized to the movement of the VR gaming controllers 130a, 130b, and transmits the synchronized VR gameplay data to the VRD 120 for display to the user 110.

In the embodiment illustrated in FIG. 1, the system 100 includes a haptic computing device (“Haptic CPU”) 150 that is configured to receive VR application data from the Game CPU 140, and to translate (as described in more detail below) the VR gameplay data received from the Game CPU 140 into a real world haptic effect that is palpable to the user 110 synchronously to the perceived haptic effect being experienced within the VR gameplay by the virtual character/avatar being controlled by the user 110. In particular, as will be discussed in more detail below, when the VR gameplay being generated by the Game CPU 140 is such that the user-controlled virtual character/avatar is experiencing one or more haptic effects (e.g., wind, heat, cold, pressure, shaking, physical damage, etc.) within the VR gameplay environment, the Haptic CPU 150 is configured to synchronously generate a corresponding haptic effect via one or more controllers 160a, 160b and haptic devices 170a, 170b. As such, the user 110, while controlling the virtual character/avatar within the VR gameplay environment via the VR gaming controllers 130a, 130b, can also experience (i.e., physically feel) the real world haptic effect corresponding to the haptic effect being experienced by the user-controller virtual character/avatar, thereby advantageously providing the user 110 with a more realistic and immersive VR experience.

In the embodiments illustrated in FIGS. 1-3, exemplary systems 100, 200, 300 include haptic devices in the form of fans 170a, 170b, 270a-d, 370a, 370b that generate the haptic effect of air flow representing wind that is physically felt by the user 110 while immersed in the VR gameplay being generated by the Game CPU 140 and displayed to the user 110 via the VRD 120. While FIGS. 1 and 3 shows systems 100 and 300 that deploy two haptic devices such as fans per user, it will be appreciated that, depending on the desired system configuration suitable for a given VR game, the number of haptic devices within a given VR system per user may be increased (e.g., from 2 to 3, from 2 to 4, from 2 to 6, from 2 to 8, or from 2 to 10, or more), or decreased (e.g., from 2 to 1. For example, the exemplary system 200 shown in FIG. 2 deploys four haptic devices 270a, 270b, 270c, 270d positioned around the user 110. All fans described herein with reference to systems 100, 200, 300 may be configured to tilt and pan to vary the angles and orientation of the fans relative to the user 110, thereby providing a wind-like effect palpable to the user 110 that is more realistically matched to the direction of the wind affecting the virtual character/avatar being controlled by the user 110 within the VR gameplay.

While the exemplary systems 100, 200, 300 illustrated in FIGS. 1-3 illustrate the haptic devices as fans configured to produce air flow representative of in-game wind affecting the user-controller virtual character/avatar, it will be appreciated that one or more of the illustrated fans may be replaced with other haptic devices (e.g., heaters, coolers, vibration vests, rumble floors, and scent generators, or the like). For example, in some aspects, while the virtual character/avatar being controlled by the user 110 is riding an all-terrain vehicle (“ATV”) through a desert (e.g., in a driving game), a system including at least one haptic device in the form of a fan and at least one haptic device in the form of a heater would generate, synchronously to the movement of the virtual character/avatar within the VR gameplay, both air flow representative of the fast in-game wind being experienced by the virtual ATV driver and heat representative of the hot in-game desert temperature being experienced by the virtual ATV driver. In other aspects, while the virtual character/avatar controlled by the user 110 is skiing down a steep slope of a snowy mountain, a system including at least one haptic device in the form of a fan, a haptic device in the form of a vibration vest and/or a rumbling floor, and at least one haptic device in the form of an air cooler would generate, synchronously to the in-game movement of the virtual character/avatar, air flow representative of the fast in-game wind being experienced by the skier and cold air representative of the cold in-game high altitude temperature being experienced by the skier, and vibration/rumbling representative of a scenario, where the virtual skier loses footing and falls (e.g., crashing into a mesh fence defining the boundaries of the virtual ski course.

In the embodiments illustrated in FIGS. 1-3, the Haptic CPUs 150, 250, 350 of systems 100, 200, 300 are configured to selectively control (i.e., activate/deactivate) each of the haptic devices 170a, 170b, 270a-d, 430a, 370b, over communication channels 165, 265, 365 (which may be wired or wireless) and the network 180, 280, 380, via controllers 160a, 160b, 260a-d, 360a, 360b that are each operatively coupled to a respective one of the haptic devices. In some embodiments, as will be described in more detail below, the Haptic CPU 150 illustrated in FIG. 1 is configured to convert VR application data (received from the Game CPU 140 and representative of the VR gameplay experienced by the user-controlled virtual character/avatar) into a haptic output data representative of a haptic effect to be selectively generated relative to the user 110 by the haptic devices 170a and/or 170b, and to then transmit a control signal including the generated haptic output data via communication channel 155 (which may be wired or wireless) and over the network 180 via a data distribution protocol to the controllers 160a, 160b that control the haptic devices 170a, 170b.

In some aspects, the controller (e.g., 160b) that receives a control signal including the haptic output data from the Haptic CPU 150 over the network 180 generates and transmits an activation signal to its respective haptic device 170b. In some aspects, the activation signal generated and transmitted by the controller 160b does not cause the haptic device 170b to simply generate air flow synchronously with the wind being experienced at a given time by the virtual character/avatar being controlled by the user 110 within the VR gameplay environment, but causes the haptic device 170b to generate air flow proportionally to (i.e., at a speed complementary to) the speed of the wind determined by the Haptic CPU 150 to correlate to the VR gameplay activity (e.g., running, falling, surfing, driving, skiing, flying, sailing, etc.) that the user-controlled virtual character/avatar is engaged in at that time. In other words, in some aspects, the haptic effect that is generated by the haptic device 170b that received the activation signal from the controller 160b (which received a control signal including haptic output data from the Haptic CPU 150) is proportional in magnitude to the haptic effects being experienced by a virtual character/avatar controlled by the user 110 within the VR gameplay.

In the exemplary embodiments illustrated in FIGS. 1-3, the components of the systems 100, 200, 300 communicate with one another via a network 180. The network 180 may be a wide-area network (WAN), a local area network (LAN), a personal area network (PAN), a wireless local area network (WLAN), Wi-Fi, Zigbee, Bluetooth (e.g., Bluetooth Low Energy (BLE) network), or any other internet or intranet network, or combinations of such networks. Generally, communication between various electronic devices of systems 100, 200, 300 may take place over hard-wired, radio frequency-based, cellular, Wi-Fi, or Bluetooth networked components, or the like. In some embodiments, one or more electronic devices of systems 100, 200, 300 may include cloud-based features, such as cloud-based memory storage. In some embodiments, the controllers 160a, 160b are configured to receive the control signal including the haptic output data from the Haptic CPU 150 via communication protocols including, but not limited to, Art-Net protocol, DMX (digital multiplex protocol), or the like. By the same token, the controllers 160a, 160b may be DMX controllers configured to receive and/or transmit DMX data.

In some embodiments, the system 100 includes one or more localized Internet-of-Things (IoT) devices and controllers in communication with the Haptic CPU 150. As a result, in some embodiments, the localized IoT devices and controllers can perform most, if not all, of the computational load and associated monitoring that would otherwise be performed by the Haptic CPU 150, and then later asynchronous uploading of summary data can be performed by a designated one of the IoT devices to the Haptic CPU 150, or a server remote to the Haptic CPU 150. In this manner, the computational effort of the overall system 100 may be reduced significantly. For example, whenever a localized monitoring allows remote transmission, secondary utilization of controllers keeps securing data for other IoT devices and permits periodic asynchronous uploading of the summary data to the Haptic CPU 150 or a server remote to the Haptic CPU 150. In addition, in an exemplary embodiment, the periodic asynchronous uploading of summary data may include a key kernel index summary of the data as created under nominal conditions. In an exemplary embodiment, the kernel encodes relatively recently acquired intermittent data (“KRI”). As a result, in an exemplary embodiment, KRI includes a continuously utilized near term source of data, but KRI may be discarded depending upon the degree to which such KRI has any value based on local processing and evaluation of such KRI. In an exemplary embodiment, KRI may not even be utilized in any form if it is determined that KRI is transient and may be considered as signal noise. Furthermore, in an exemplary embodiment, the kernel rejects generic data (“KRG”) by filtering incoming raw data using a stochastic filter that provides a predictive model of one or more future states of the system and can thereby filter out data that is not consistent with the modeled future states which may, for example, reflect generic background data. In an exemplary embodiment, KRG incrementally sequences all future undefined cached kernels of data in order to filter out data that may reflect generic background data. In an exemplary embodiment, KRG incrementally sequences all future undefined cached kernels having encoded asynchronous data in order to filter out data that may reflect generic background data.

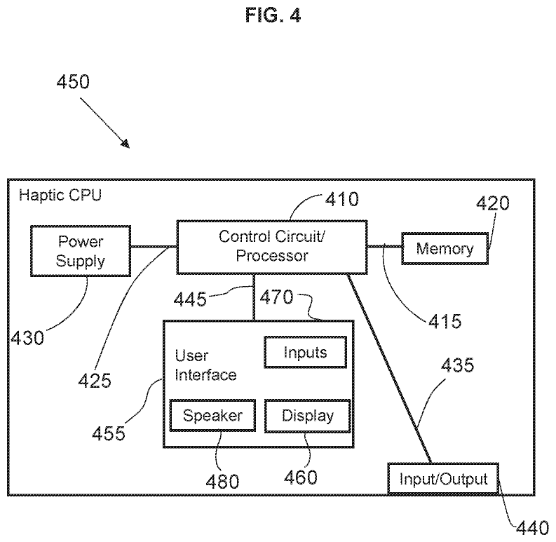

With reference to FIG. 4, the exemplary Haptic CPU 450 is a computer-based device and includes a processor-based control circuit/processor 410 (for example, a microprocessor or a microcontroller) electrically coupled via a connection 415 to a memory 420 and via a connection 425 to a power supply 430. The control circuit 410 of the Haptic CPU 450 can comprise a fixed-purpose hard-wired platform or can comprise a partially or wholly programmable platform, such as a microcontroller, an application specification integrated circuit, a field programmable gate array, and so on. These architectural options are well known and understood in the art and require no further description.

The control circuit 410 of the Haptic CPU 450 can be configured (for example, by using corresponding programming stored in the memory 420 as will be well understood by those skilled in the art) to carry out one or more of the steps, actions, and/or functions described herein. In some embodiments, the memory 420 may be integral to the control circuit 410 of the Haptic CPU 450, or can be physically discrete (in whole or in part) from the control circuit 410 and is configured non-transitorily store the computer instructions that, when executed by the control circuit 410, cause the control circuit 410 to behave as described herein.

As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM)) as well as volatile memory (such as an erasable programmable read-only memory (EPROM)). Accordingly, the memory 420 and/or the control circuit 410 of the Haptic CPU 450 may be referred to as a non-transitory medium or non-transitory computer readable medium. The control circuit 410 of the Haptic CPU 450 is also electrically coupled via a connection 435 to an input/output 440 that can, for example, receive (e.g., via the wireless or wired communication channel 145 of FIG. 1) VR application data from the Game CPU 140, as well as to send (e.g., via the wireless or wired communication channel 155 of FIG. 1) control signals including haptic output data to the controllers 160a, 160b.

In the embodiment shown in FIG. 4, the processor-based control circuit 410 of the Haptic CPU 450 is electrically coupled via a connection 445 to a user interface 455, which may include a visual display or display screen 460 (e.g., LED screen) and/or button inputs 470 that provide the user interface 455 with the ability to permit an operator (e.g., VR game master) to manually control the Haptic CPU 450 by inputting commands, for example, via touch-screen and/or button operation or voice commands. In some aspects, the display screen 460 permits the operator to see various menus, options, and/or alerts displayed by the Haptic CPU 450. The user interface 455 of the Haptic CPU 450 may also include a speaker 480 that may provide audible feedback (e.g., alerts) to the operator.

In some embodiments, as described above, the Game CPU 140 is configured to derive/generate VR application data based on the movement/actions/interactions of the virtual character/avatar (which may affect any of the senses (e.g., physical touch, temperature, pressure, vibrations, etc.) of the virtual character/avatar) controlled by the user 110 (e.g., via the VR gaming controllers 130a, 130b) within the VR gameplay environment. In other embodiments, the Game CPU 140 is configured to derive/generate VR application data based on preprogrammed/pre-stored hand-tailored (i.e., custom) values associated with the movement/actions/interactions of the virtual character/avatar controlled by the user 110 within the VR gameplay environment. In some aspects, the Game CPU 140 is configured to transmit (e.g., via the communication channel 145 and over the network 180) this VR application data to the Haptic CPU 150.

In some embodiments, the control circuit 410 of the Haptic CPU 450 of FIG. 2 is configured (e.g., via the input/output 440) to receive, from one or more gaming CPUs (e.g., 140 or 340a and 340b) and over the network 180, VR application data indicative of the VR gameplay displayed via one or more VRDs (e.g., 120 or 320a, 320b) to one (e.g., 110) or more (e.g., 310a, 310b) users. In certain aspects, the processor 410 is programmed to convert the VR application data received from the Game CPUs into haptic output data. In some embodiments, the haptic output data is based on a correlation, by the processor 410 of the Haptic CPU 450, of the speed of movement of the user-controlled virtual character/avatar and/or the speed of one or more environmental objects within the VR gameplay, to a projected/predicted magnitude (i.e., speed) and direction of in-game wind that would affect the virtual character/avatar within the VR gameplay. In one embodiment, the processor 410 of the Haptic CPU 450 is programmed to extract, from the VR application data received from the Game CPU 140, first haptic data indicative of haptic effects being experienced by a virtual character/avatar within the VR gameplay, and to incorporate, into the haptic output data, second haptic data that is proportional in magnitude to the haptic effects being experienced by the virtual character/avatar within the VR gameplay.

In certain multi-player implementations akin to the exemplary system 300 shown in FIG. 3, the Haptic CPU 350 is configured to receive multiple streams of VR application data from two (or more) Game CPUs 340a, 340b over the network 180 and to detect the VR application data (if any) that is indicative of VR gameplay in which the virtual character/avatar is presently experiencing haptic effects (e.g., wind, high heat, freezing cold, physical damage, etc.). In certain aspects, the generated haptic output data is based on a correlation, by the processor 410 of the Haptic CPU 450, of the speed of movement of the user-controlled virtual character/avatar and/or the speed of one or more environmental or other objects within the VR gameplay, to a calculated magnitude (i.e., speed) and direction of in-game wind that would affect the virtual character/avatar within the VR gameplay.

In other words, when a first stream of VR application data received from Game CPU 340a over the network 180 is indicative, for example, of VR gameplay, where the virtual character/avatar is riding a skateboard down a ramp, and a second stream of VR application data received from Game CPU 340b is indicative, for example, of VR gameplay, where the virtual character/avatar is driving a racecar along a racetrack, the correlation by the processor of the Haptic CPU 350 of the received VR application data to the calculated wind speed would result in haptic output data that will cause significantly faster movement of the blades of the fan 370b associated with the Game CPU 340b as compared to the movement of the blades of the fan 370a associated with the Game CPU 340. In some aspects, the haptic output data generated by the Haptic CPU 350 to be transmitted (via the controller 360c and/or 360d) to haptic device 370c and/or 370d associated with the user 310b will include second haptic data that is proportional to the speed of a racecar and will cause significantly faster movement of the blades of the fan 370b, while the haptic output data generated by the Haptic CPU 350 to be transmitted (via the controller 360a and/or 360b) to haptic device 370a and/or 370b associated with the user 310a will include second haptic data that is proportional to the speed of a skateboard and will cause significantly slower movement of the blades of the fan 370a.

In certain multiplayer implementations akin to the exemplary system 300 shown in FIG. 3, VR gameplay being experienced by the virtual characters/avatars controlled by the users 310a, 310b may be different in that, at a given time, the virtual character/avatar controlled by user 310a may be experiencing an in-game haptic effect such as wind or heat or cold (e.g., due to the virtual character/avatar driving a car or being in adverse in-game weather conditions), while the virtual character/avatar controlled by user 310b may not be experiencing an in-game haptic effect such as wind or heat or cold (e.g., due to user hiding within a house by standing still in basement). In such multi-player situations where some user-controlled virtual characters/avatars are experiencing in-game haptic effects and some are not, the processor of the Haptic CPU 350 is programmed to selectively control (e.g., activate/not activate/deactivate) the haptic devices 370a, 370b, 370c, 370d of the system 300 such that one (or two or three) of the haptic devices (e.g., 370b) is activated by the Haptic CPU 350 via the controller 360a and the remaining haptic devices (e.g., 370a and/or 370c and/or 370d) are not.

In some aspects, if the processor of the Haptic CPU 350 detects, in the VR application data stream received from the Game CPU 340a (but not in the VR application data stream received from the Game CPU 340b), first haptic data indicative of the virtual character/avatar experiencing haptic effects, the processor of the Haptic CPU 350 is programmed to selectively convert the VR application data received from Game CPU 340a into haptic output data that will ultimately cause the haptic device 370b to be activated via the controller 360b to produce wind-like air flow without converting the VR application data received from Game CPU 340b into haptic output data and allowing the haptic devices 370a, 370c, and 370d to remain inactivated (or to be deactivated via their respective controllers). As discussed above, the haptic output data generated by the Haptic CPU 350 to be transmitted (via the controller 360b) to haptic device 370b associated with the user 310a will include second haptic data that is proportional to the speed of a racecar and will cause faster movement of the blades of the fan 370b when the virtual car is moving forward faster within the VR gameplay and slower movement of the blades of the fan 370b when the virtual car is moving forward slower within the VR gameplay.

With reference to FIGS. 3 and 4, in some aspects, after generating the haptic output data based on an correlation analysis and conversion of the VR application data into haptic output data, the processor 410 of the Haptic CPU 450 is programmed to generate and transmit (e.g., in DMX format as discussed above) a control signal including the generated haptic output data (which may, as discussed above, include second haptic data indicating magnitude of the haptic effect to be produced in proportion to the in-game haptic effects) over the network 180 to a selected one or more of the controllers 360a, 360b, 360c, 360d that control their respective haptic devices 370a, 370b. In the racecar example above, the controller 360b that receives a control signal including the haptic output data (which may include the second haptic data) from the Haptic CPU 350, generates and transmits an activation signal to its respective haptic device 370b. As mentioned above, the activation signal transmitted by the controller 360b may turn on the haptic device 370b from an OFF state and causes the haptic device 370b to synchronously generate air flow at a speed complementary (i.e., fast speed) to the speed of the wind determined by the Haptic CPU 350 to correspond to the VR gameplay activity (i.e., driving a race car) that the virtual character/avatar being controlled by the user 310a is engaged in at the time.

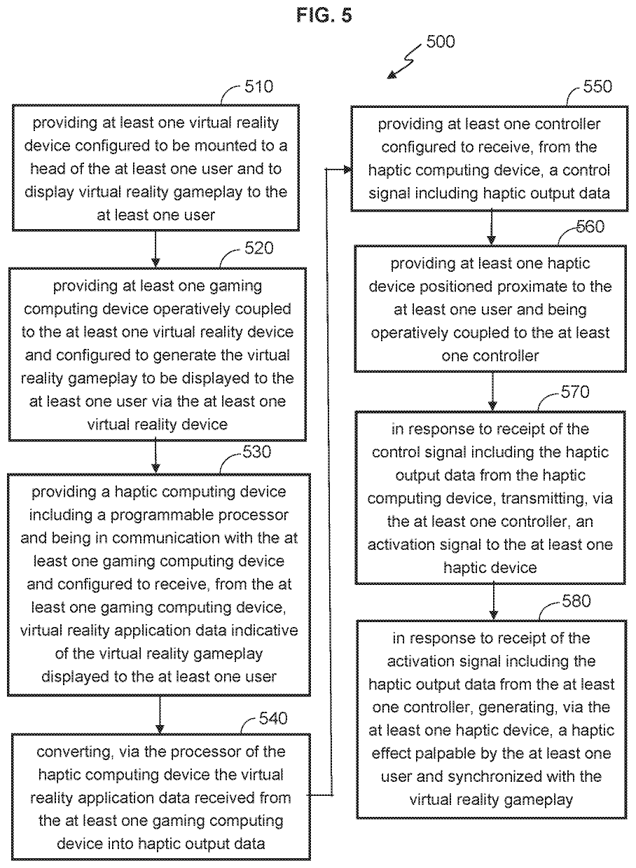

With reference to FIGS. 1-5, one method 500 of operation of the system 100 will now be described. For exemplary purposes, the method 500 depicted by way of a block diagram in FIG. 5 is described in the context of the systems 100 and 300 of FIGS. 1 and 3, but it is understood that embodiments of the method 500 may be implemented in other VR systems.

The exemplary method 500 for providing synchronous haptic feedback to one or more users during a VR experience includes providing one or more virtual reality devices (e.g., 120) configured to be mounted to a head of one or more users (e.g., 110) and to display VR gameplay to one or more users (block 510). In addition to providing one or more virtual reality devices (120, 320a, and/or 320b) that are configured to display the VR gameplay to one or more users (110, 310a, and/or 310b), the method 500 further includes providing one or more gaming computing devices (140, 340a, and/or 340b) operatively coupled to the virtual reality devices (120, 320a, and/or 320b) and configured to generate the VR gameplay to be displayed to the user(s) (110, 310a, and/or 310b) via the VRD(s) (120, 320a, and/or 320b) (block 520).

In the embodiment illustrated in FIG. 5, the method 500 further includes providing a haptic computing device (150, 350) including a programmable control circuit/processor (410) and being in communication with one or more gaming computing devices (140, 340a, and/or 340b) and configured to receive, from the gaming computing device(s) (140, 340a, and/or 340b), VR application data indicative of the VR gameplay displayed to the user(s) (110, 310a, and/or 310b) (block 530). The method 500 illustrated in FIG. 5 additionally includes converting, via the processor (410) of the haptic computing device (150, 350), the VR application data received from the gaming computing device(s) (140, 340a, and/or 340b) into haptic output data (block 540).

The method 500 further includes providing one or more haptic device controllers (160, 360a, 360b, 360c, and/or 360d) configured to receive, from the haptic computing device (150, 350), a control signal including the haptic output data (block 550), and well as providing one or more haptic devices (170, 370a, 370b, 370c, and/or 370d) positioned proximate to the user(s) (110, 310a, 310b) and being operatively coupled to haptic device controller(s) (160, 360a, 360b, 360c, and/or 360d) (block 560). During operation of the method 500 illustrated in FIG. 5, in response to receipt by one or more haptic device controller(s) (160, 360a, 360b, 360c, and/or 360d) of the control signal including the haptic output data from the haptic computing device (150, 350), transmitting, via one or more haptic device controller(s) (160, 360a, 360b, 360c, and/or 360d), an activation signal to one or more haptic device(s) (170, 370a, 370b, 370c, and/or 370d) (block 570). In addition, in response to receipt of the activation signal including the haptic output data from a haptic device controller (160, 360a, 360b, 360c, and/or 360d), generating, via one or more respective haptic device(s) (170, 370a, 370b, 370c, and/or 370d), a haptic effect palpable by the user(s) (110, 310a, 310b) and synchronized with the VR gameplay (block 580).

As mentioned above, in some aspects, the method 500 further includes providing one or more gaming chairs (190, 390a, and/or 390b) configured to support the user(s) (110, 310a, 310b) during the VR experience and transmitting a signal via the haptic computing device (150, 350) in order to cause the gaming chair(s) (190, 390a, and/or 390b) to tilt synchronously with the VR gameplay. In some aspects, the method 500 includes extracting, via the processor of the Haptic CPU 150 and from the VR application data received from the gaming computing device 140, first haptic data indicative of haptic effects being experienced by a virtual character within the VR gameplay and incorporating, via the processor of the Haptic CPU 150, into the haptic output data, second haptic data that is proportional in magnitude to the haptic effects being experienced by the virtual character within the VR gameplay.

In some aspects, the method 500 may further include providing one or more hand-held VR gaming controllers (130a, 130b, 330a, 330b, 330c, 330d) in communication with the gaming computing device (140, 340a, 340b) and controlling, via the gaming computing device (140, 340a, 340b), movement of a virtual character within the VR gameplay in response to manipulation of the VR gaming controller(s) (130a, 130b, 330a, 330b, 330c, 330d) by the user(s) (110, 310a, 310b). As mentioned above, the VR gaming controllers (130a, 130b, 330a-d) are optional in certain embodiments. In addition, as mentioned above, in some multi-player implementations, the method 500 may include selectively activating any one of the haptic devices (370a-d) associated with any one of the users (310a or 310b) via the processor of the haptic computing device 350 and based on an analysis by the processor of the haptic computing device 350 of multiple streams of the VR application data received from the gaming computing devices (140, 340a, 340b).

The systems and methods described herein provide for realistic generation of haptic effects palpable by the user in a synchronous and proportional fashion relative to the haptic effects affecting the virtual character/avatar being controlled by the user within the VR gameplay. The methods and systems described herein employ both a VR gaming computer that generates VR application data representative of the VR gameplay viewable by the user via a head-mounted VRD, and a dedicated haptic computer that processes the operations required to convert the VR application data generated by the VR gaming computer into haptic output data, which is then transmitted by the haptic computer to one or more selected haptic device controllers, which then activate, one or more selected devices to generate, the haptic computer-determined haptic effects synchronously to the VR gameplay and at levels of magnitude proportional to the action within the VR gameplay. Accordingly, the systems and methods described herein advantageously reproduce, synchronously, and in a proportion complementary to the VR gameplay, one or more haptic effects for VR users without significantly increasing the computing power required for the VR gaming computer to render such haptic effects.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system for providing synchronous haptic feedback to at least one user during a virtual reality experience, the system comprising:
at least one virtual reality device configured to be mounted to a head of the at least one user and to display virtual reality gameplay to the at least one user;
at least one gaming computing device operatively coupled to the at least one virtual reality device and configured to generate the virtual reality gameplay to be displayed to the at least one user via the at least one virtual reality device;
a haptic computing device including a programmable processor and being in communication with the at least one gaming computing device and configured to receive, from the at least one gaming computing device, virtual reality application data indicative of the virtual reality gameplay displayed to the at least one user, the processor of the haptic computing device being programmed to convert the virtual reality application data received from the at least one gaming computing device into haptic output data;
at least one controller configured to receive, from the haptic computing device, a control signal including the haptic output data; and
at least one haptic device positioned proximate to the at least one user and being operatively coupled to the at least one controller;
wherein, in response to receipt by the at least one controller of the control signal including the haptic output data from the haptic computing device, the at least one controller is configured to transmit an activation signal to the at least one haptic device; and
wherein, in response to receipt by the at least one haptic device of the activation signal including the haptic output data from the at least one controller, the at least one haptic device is configured to generate a haptic effect palpable by the at least one user and synchronized with the virtual reality gameplay.

2. The system of claim 1, further comprising at least one gaming chair configured to support the at least one user during the virtual reality experience, the at least one gaming chair being configured to tilt synchronously with the virtual reality gameplay in response to a signal transmitted by the haptic computing device.

3. The system of claim 2, wherein the at least one gaming chairs includes the at least one haptic device physically incorporated therein.

4. The system of claim 1, wherein the virtual reality application data indicates physical movement of a virtual character within the virtual reality gameplay and environmental elements being interacted with by the virtual character within the virtual reality gameplay.

5. The system of claim 4, wherein the processor of the haptic computing device is programmed to:
extract, from the virtual reality application data received from the gaming computing device, first haptic data indicative of haptic effects being experienced by a virtual character within the virtual reality gameplay; and
incorporate, into the haptic output data, second haptic data that is proportional in magnitude to the haptic effects being experienced by the virtual character within the virtual reality gameplay.

6. The system of claim 1, further comprising at least one hand-held controller in communication with the gaming computing device and configured to control movement of a virtual character within the virtual reality game play in response to manipulation of the at least one hand-held controller by the at least one user.

7. The system of claim 6, wherein the at least one hand-held controller is configured to detect at least one of physical location, orientation, direction of movement, and speed of movement of the at least one hand-held controller by the at least one user and to transmit, via a wired or wireless communication channel, the at least one of physical location, orientation, direction of movement, and speed of movement of the at least one hand-held controller to the at least one gaming computing device.

8. The system of claim 1, wherein:
the at least one user is a plurality of users:
the at least one virtual reality device is a plurality of virtual reality devices each mounted to the head of a respective one of the plurality of users;
the at least one gaming computing device is a plurality of gaming computing devices each operatively coupled to a respective one of the virtual reality devices;
the at least one controller is a plurality of controllers;
the at least one haptic device is a plurality of haptic devices each operatively coupled to a respective one of the controllers;
the haptic computing device is in communication over the network with the plurality of the gaming computing devices and with the plurality of the controllers; and
wherein the processor of the haptic computing device is programmed to, based on an analysis by the processor of multiple streams of the virtual reality application data received from the plurality of the gaming computing devices, to selectively activate any one of the plurality of the haptic devices associated with any one of the users.

9. The system of claim 1, wherein:
the at least one virtual reality device is in communication with the gaming computing device over a wireless or a wired connection;
the haptic computing device is in communication with the at least one gaming computing device over a wireless or a wired connection;
the at least one controller is in communication with the haptic device over a wireless or a wired connection; and
the at least one haptic device is in communication with the at least one controller over a wireless or a wired connection.

10. The system of claim 1, wherein the at least one haptic device is at least one of a fan, heater, cooler, vibration vest, rumble floor, and scent generator.

11. A method for providing synchronous haptic feedback to at least one user during a virtual reality experience, the method comprising:
providing at least one virtual reality device configured to be mounted to a head of the at least one user and to display virtual reality gameplay to the at least one user;
providing at least one gaming computing device operatively coupled to the at least one virtual reality device and configured to generate the virtual reality gameplay to be displayed to the at least one user via the at least one virtual reality device;
providing a haptic computing device including a programmable processor and being in communication with the at least one gaming computing device and configured to receive, from the at least one gaming computing device, virtual reality application data indicative of the virtual reality gameplay displayed to the at least one user;
converting, via the processor of the haptic computing device the virtual reality application data received from the at least one gaming computing device into haptic output data;
providing at least one controller configured to receive, from the haptic computing device, a control signal including the haptic output data;
providing at least one haptic device positioned proximate to the at least one user and being operatively coupled to the at least one controller;
in response to receipt by the at least one controller of the control signal including the haptic output data from the haptic computing device, transmitting, via the at least one controller, an activation signal to the at least one haptic device; and
in response to receipt by the at least one haptic device of the activation signal including the haptic output data from the at least one controller, generating, via the at least one haptic device, a haptic effect palpable by the at least one user and synchronized with the virtual reality gameplay.

12. The method of claim 11, further comprising:
providing at least one gaming chair configured to support the at least one user during the virtual reality experience; and
transmitting a signal via the haptic computing device in order to cause the at least one gaming chair to tilt synchronously with the virtual reality gameplay.

13. The method of claim 12, further comprising physically incorporating the at least one haptic device into the at least one gaming chair.

14. The method of claim 11, wherein the virtual reality application data indicates physical movement of a virtual character within the virtual reality gameplay and environmental elements being interacted with by the virtual character within the virtual reality gameplay.

15. The method of claim 14, further comprising:
extracting, via the processor of the haptic computing device and from the virtual reality application data received from the gaming computing device, first haptic data indicative of haptic effects being experienced by a virtual character within the virtual reality gameplay; and
incorporating, via the processor of the haptic computing device, into the haptic output data, second haptic data that is proportional in magnitude to the haptic effects being experienced by the virtual character within the virtual reality gameplay.

16. The method of claim 11, further comprising:
providing at least one hand-held controller in communication with the gaming computing device; and
controlling, via the at least one gaming computing device, movement of a virtual character within the virtual reality gameplay in response to manipulation of the at least one hand-held controller by the at least one user.

17. The method of claim 16, further comprising:
detecting, via the at least one hand-held controller, at least one of physical location, orientation, direction of movement, and speed of movement of the at least one hand-held controller by the at least one user; and
transmitting, to the at least one gaming computing device via a wired or wireless communication channel, the at least one of physical location, orientation, direction of movement, and speed of movement of the at least one hand-held controller to the at least one gaming computing device.

18. The method of claim 11, wherein:
the at least one user is a plurality of users:
the at least one virtual reality device is a plurality of virtual reality devices each mounted to the head of a respective one of the plurality of users;
the at least one gaming computing device is a plurality of gaming computing devices each operatively coupled to a respective one of the virtual reality devices;
the at least one controller is a plurality of controllers;
the at least one haptic device is a plurality of haptic devices each operatively coupled to a respective one of the controllers; and
the haptic computing device is in communication over the network with the plurality of the gaming computing devices and with the plurality of the controllers;
further comprising selectively activating any one of the plurality of the haptic devices associated with any one of the users via the processor of the haptic computing device and based on an analysis by the processor of multiple streams of the virtual reality application data received from the plurality of the gaming computing devices.

19. The method of claim 11, wherein:
the at least one virtual reality device is in communication with the gaming computing device over a wireless or a wired connection;
the haptic computing device is in communication with the at least one gaming computing device over a wireless or a wired connection;
the at least one controller is in communication with the haptic device over a wireless or a wired connection; and
the at least one haptic device is in communication with the at least one controller over a wireless or a wired connection.

20. The method of claim 11, wherein the at least one haptic device is at least one of a fan, heater, cooler, vibration vest, rumble floor, and scent generator.
